(19) United States
(12) Patent Application Publication
(10) Pub. No.: US 2009/0268056 A1
(43) Pub. Date: Oct. 29, 2009

(54) DIGITAL CAMERA WITH PORTRAIT IMAGE PROTECTING FUNCTION AND PORTRAIT IMAGE PROTECTING METHOD THEREOF

(75) Inventor: TAO-CHUNG WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/239,734

(22) Filed: Sep. 26, 2008

(30) Foreign Application Priority Data
Apr. 28, 2008 (CN) 200810301378.X

(51) Int. Cl. H04N 5/76

(52) U.S. Cl. 348/231.2; 348/E05.031

(57) ABSTRACT

A digital camera includes a storage medium storing a plurality of images that include a portrait image, a face detection unit configured for detecting the portrait image from the plurality of images, a user input unit configured for receiving a cipher in response to a user's input, an encrypting unit configured for encrypting the portrait image using the received cipher to form an encrypted file associated with the portrait image, and a deleting unit configured for deleting the portrait image.

### BACKGROUND

1. Field of the Invention

The present invention relates to a digital imaging technology and, particularly, to a digital camera with a portrait image protecting function and a portrait image protecting method thereof.

2. Description of the Related Art

Many digital cameras allow users to view and edit images stored therein. However, this convenient feature may lead to privacy leakages and unauthorized editing of the images, especially for private portrait images when the digital cameras have been lent or lost.

What is needed, therefore, is to provide a digital camera with a portrait image protecting function and a portrait image protecting method thereof.

### BRIEF DESCRIPTION OF THE DRAWINGS

FIG. 1 is a structural block diagram of a digital camera according to an exemplary embodiment.

FIG. 2 is a flowchart of a portrait image protecting method of the digital camera of FIG. 1, according to an exemplary embodiment.

### DETAILED DESCRIPTION OF THE EMBODIMENTS

All of the processes described below may be embodied in, and fully automated via, software code units executed by one or more general purpose computers or processors. The code units may be stored in any type of computer-readable medium or other computer storage device. Some or all of the methods may alternatively be embodied in specialized computer hardware.

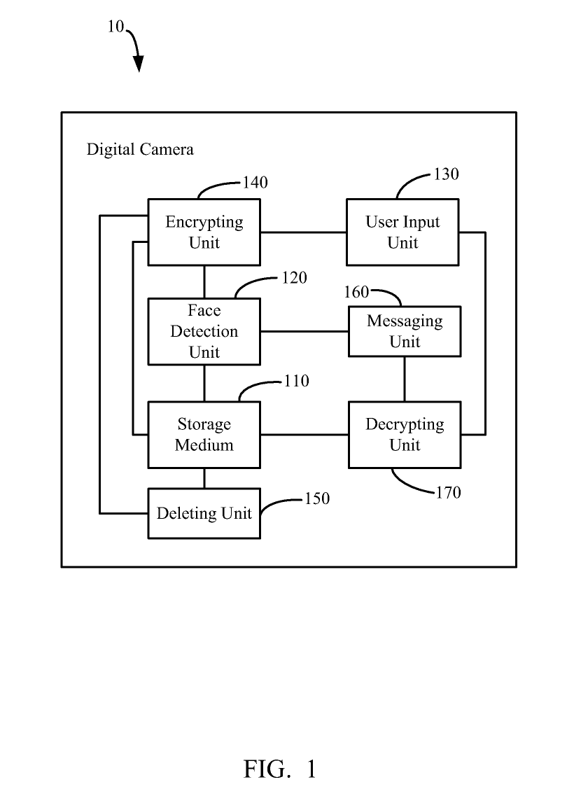

Referring to FIG. 1, a digital camera 10 includes a storage medium 110, a face detection unit 120, a user input unit 130, an encrypting unit 140 and a deleting unit 150. The face detection unit 120, the user input unit 130, the encrypting unit 140 and the deleting unit 150 may be pre-stored in the read-only memory (ROM) of the digital camera 10, and executed by a Digital Signal Processor (DSP) built in the digital camera 10.

The storage medium 110 stores a number of images, including portrait images. The storage medium 110 may be an internal memory of the digital camera 10 and/or an external memory card inserted into the digital camera 10. The images may be in the format of, joint-photographic experts group, graphics-interchange or bitmap.

The face detection unit 120 is configured for detecting the portrait images among the images. The face detection 120 detects one or more portrait images among the images.

The user input unit 130 is configured for receiving a cipher in response to a user's input. The user may input the cipher using certain functional keys on the digital camera 10. The digital camera 10 further includes a messaging unit 160. The messaging unit 160 is configured for prompting the user to input the cipher after a portrait image has been detected. The prompting method may be video or audio.

The encrypting unit 140 is configured for encrypting the portrait image using the received cipher to form an encrypted file associated with the portrait image. The encrypting unit 140 may use data encryption standards to implement the encryption. The encrypted file may be stored in the storage medium 110. In this embodiment, the format of the encrypted file is a zone information protocol format.

The deleting unit 150 is configured for deleting the portrait image. If the face detection unit 120 detects a number of portrait images, the encrypted unit 140 encrypts the portrait images using a same cipher or different ciphers, depending on the user's inputs. Therefore, the portrait images are protected.

For convenient review of the protected portrait images on the digital camera 10, the digital camera 10 further includes a decrypting unit 170. The decrypting unit 170 is configured for receiving a key and decrypting the encrypted file using the key to retrieve the portrait images. The user may input the key using certain functional keys on the digital camera 10. The portrait images may be displayed on a display (not shown) of the digital camera 10 in a thumbnail fashion.

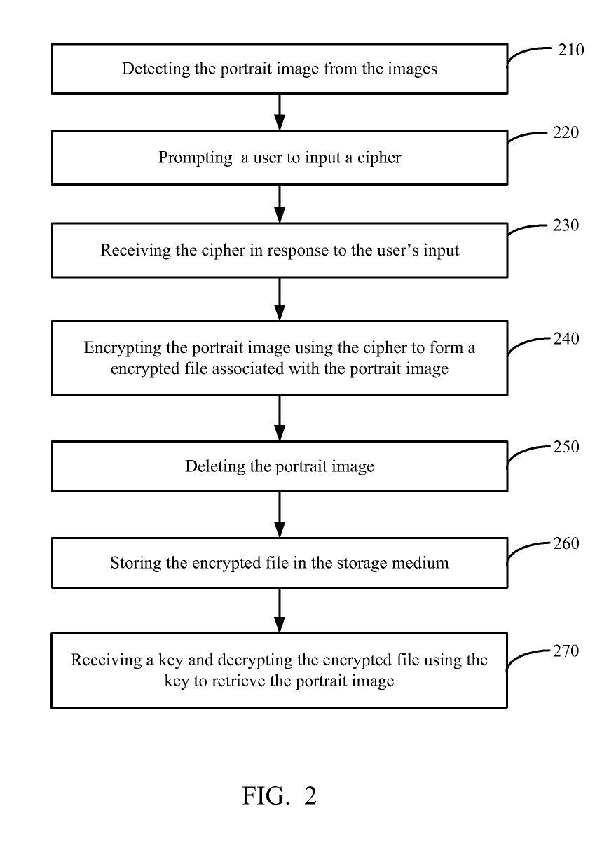

Referring to FIG. 2, a portrait image protecting method, according to an exemplary embodiment, of the digital camera 10 includes step 210 to step 270. Step 210: detecting the portrait images from the images. Step 220: prompting a user to input a cipher. Step 230: receiving a cipher in response to a user's input. Step 240: encrypting the portrait image using the received cipher to form an encrypted file associated with the portrait image. Step 250: deleting the portrait image. Step 260: storing the encrypted file in the storage medium. Step 270: receiving a key and decrypting the encrypted file using the key to retrieve the portrait image.

In summary, the digital camera 10 can encrypt the portrait images using the cipher, thereby protecting the portrait image.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital camera comprising:
a storage medium storing a plurality of images that include a portrait image;
a face detection unit configured for detecting the portrait image from the plurality of images;
a user input unit configured for receiving a cipher in response to a user's input;
an encrypting unit configured for encrypting the portrait image using the received cipher to form an encrypted file associated with the portrait image; and
a deleting unit configured for deleting the portrait image.

2. The digital camera as claimed in claim 1, wherein the format of the encrypted file is a zone information protocol format.

3. The digital camera as claimed in claim 1, further comprising a decryption unit configured for receiving a key and decrypting the encrypted file to retrieve the portrait image using the key.

4. The digital camera as claimed in claim 1, further comprising a messaging unit configured for prompting a user to input the cipher.

5. A digital camera comprising:
a storage medium storing an image;
a face detection unit configured for detecting whether the image is a portrait image;
a user input unit configured for receiving a cipher in response to a user's input if the image is a portrait image;
an encryption unit configured for encrypting the portrait image using the received cipher to form an encrypted file associated with the portrait image; and
a deleting unit configured for deleting the portrait image.

6. The digital camera as claimed in claim 5, wherein the format of the encrypted file is a zone information protocol format.

7. The digital camera as claimed in claim 5, further comprising a decryption unit configured for receiving a key and decrypting the encrypted file using the key to retrieve the portrait image.

8. The digital camera as claimed in claim 5, further comprising a messaging unit configured for prompting a user to input the cipher if the image is a portrait image.

9. A portrait image protecting method of a digital camera, comprising:
detecting a portrait image from;
receiving a cipher in response to a user's input;
encrypting the portrait image using the received cipher to form an encrypted file associated with the portrait image; and
deleting the portrait image.

10. The method as claimed in claim 9, further comprising:
receiving a key and decrypting the encrypted file using the key to retrieve the portrait image.

11. The method as claimed in claim 9, further comprising:
prompting a user to input the cipher if the image is portrait image.
